(19) United States
(12) Patent Application Publication
(10) Pub. No.: US 2004/0258844 A1
(43) Pub. Date: Dec. 23, 2004

(54) Nonwoven cleaning articles having compound three-dimensional images

(75) Inventors: Miguel Rivera, Mooresville, NC (US); Ralph A. Moody III, Mooresville, NC (US); Benjamin Nolan, Elmer, NJ (US); Michael J. Putnam, Fuquay-Varina, NC (US); Nick Carter, Mooresville, NC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/819,880

(22) Filed: Apr. 7, 2004

Related U.S. Application Data
(60) Provisional application No. 60/462,270, filed on Apr. 11, 2003.

(51) Int. Cl. B05D 1/30

(52) U.S. Cl. 427/420; 28/104; 427/421.1

(57) ABSTRACT

The present invention is directed to a method of forming a nonwoven cleaning article, which exhibits a first three-dimensional image and a second three-dimensional image whereby the first and second three-dimensional images are dissimilar from one another. In particular, the present invention contemplates a fabric comprised of sequential three-dimensional images that are formed from a pre-entangled precursor web entangled on a first three-dimensional transfer device so as to impart a first image therein, then subjected to hydroentanglement on a second three-dimensional image transfer device wherein a second three-dimensional image is imparted to the web that is different from the first three-dimensional image, the resulting nonwoven cleaning article presenting aesthetic and tactile qualities representative of both imparted images.

### TECHNICAL FIELD

The present invention relates generally to methods of making nonwoven cleaning articles, and more particularly, to a method of manufacturing a nonwoven cleaning article exhibiting improved physical characteristics while exhibiting a first three-dimensional image and a second three-dimensional image whereby the first and second three-dimensional images are dissimilar, permitting use of the fabric in a wide variety of consumer applications.

### BACKGROUND OF THE INVENTION

Nonwoven fabrics are suitable for use in a wide variety of applications where the efficiency with which the fabrics can be manufactured provides a significant economic advantage for these fabrics versus traditional textiles. However, nonwoven fabrics have commonly been disadvantaged when fabric properties are compared to conventional textiles, particularly in terms of resistance to elongation, in applications where both transverse and co-linear stresses are encountered. Hydroentangled fabrics have been developed with improved properties, by the formation of complex composite structures in order to provide a necessary level of fabric integrity. Subsequent to entanglement, fabric durability has been further enhanced by the application of binder compositions and/or by thermal stabilization of the entangled fibrous matrix.

Nonwoven composite structures typically improve physical properties, such as elongation, by way of incorporation of a support layer or scrim. The support layer material can comprise an array of polymers, such as polyolefins, polyesters, polyurethanes, polyamides, and combinations thereof, and take the form of a film, fibrous sheeting, or grid-like meshes. Metal screens, fiberglass, and vegetable fibers are also utilized as support layers. The support layer is commonly incorporated either by mechanical or chemical means to provide reinforcement to the composite fabric. Reinforcement layers, also referred to as a “scrim” material, are described in detail in U.S. Pat. No. 4,636,419, which is hereby incorporated by reference. The use of scrim material, more particularly, a spunbond scrim material is known to those skilled in the art.

Spunbond material comprises continuous filaments typically formed by extrusion of thermoplastic resins through a spinneret assembly, creating a plurality of continuous thermoplastic filaments. The filaments are then quenched and drawn, and collected to form a nonwoven web. Spunbond materials have relatively high resistance to elongation and perform well as a reinforcing layer or scrim. U.S. Pat. No. 3,485,706 to Evans, et al., which is hereby incorporated by reference, discloses a continuous filament web with an initial random staple fiber batt mechanically attached via hydroentanglement, then a second random staple fiber batt is attached to the continuous filament web, again, by hydroentanglement. A continuous filament web is also utilized in U.S. Pat. No. 5,144,729; No. 5,187,005; and No. 4,190,695. These patents include a continuous filament web for reinforcement purposes or to reduce elongation properties of the composite.

More recently, hydroentanglement techniques have been developed which impart images or patterns to the entangled fabric by effecting hydroentanglement on three-dimensional image transfer devices. Such three-dimensional image transfer devices are disclosed in U.S. Pat. No. 5,098,764, which is hereby incorporated by reference; with the use of such image transfer devices being desirable for providing a fabric with enhanced physical properties as well as an aesthetically pleasing appearance. It has been envisioned through the use of such three-dimensional image transfer devices that a compound three-dimensionally imaged cleaning article can be formed for use in various cleaning applications.

For specific cleaning applications, it's desirable that a three-dimensionally imaged nonwoven fabric exhibit a combination of specific physical characteristics. For example, when such fabrics are used in the formation of cleansing or dusting wipes, the fabric must exhibit sufficient durability to withstand application upon abrasive surfaces and yet exhibit a pronounced three-dimensional pattern so as to capture and retain particulates. Further, three-dimensionally imaged nonwoven fabrics used in various cleaning applications require sufficient resistance to elongation so as to resist deformation of the image when the fabric is converted into a final end-use article and when used in the final application.

A need exists for a compound three-dimensionally imaged nonwoven cleaning article acceptable for home, personal, medical, and industrial applications, which provides a pronounced compound image for enhanced cleaning purposes, as well as the requisite mechanical characteristics.

### SUMMARY OF THE INVENTION

The present invention is directed to a method of forming a nonwoven cleaning article, which exhibits a first three-dimensional image and a second three-dimensional image whereby the first and second three-dimensional images are dissimilar from one another. In particular, the present invention contemplates a fabric comprised of sequential three-dimensional images that are formed from a pre-entangled precursor web entangled on a first three-dimensional transfer device so as to impart a first image therein, then subjected to hydroentanglement on a second three-dimensional image transfer device wherein a second three-dimensional image is imparted to the web that is different from the first three-dimensional image, the resulting nonwoven cleaning article presenting aesthetic and tactile qualities representative of both imparted images.

In accordance with the present invention, a method of making a nonwoven cleaning article comprises the steps of providing a precursor web comprising a fibrous matrix. While use of staple length fibers is typical, the fibrous matrix may comprise substantially continuous filaments. In a particularly preferred form, the fibrous matrix comprises staple length fibers, which are carded and cross-lapped to form a precursor web. In one embodiment, one or more layers of fibrous matrix are juxtaposed with one or more support layers or scrims, then the layered construct is pre-entangled on a first foraminous surface to form a precursor web comprised of a first three-dimensional image, which is either directly imparted with a second imaged, or subjected to further fiber, filament, support layers, or scrim layers prior to hydroentanglement on a second image transfer device imparting a second three-dimensional image.

The present method further contemplates the provision of at least a first and a second three-dimensional image transfer device, each having an independent and movable imaging surface. In a typical configuration, the one or more of the image transfer devices may comprise a drum-like apparatus, which is rotatable with respect to one or more hydroentangling manifolds.

Subsequent to hydroentanglement, the three-dimensionally imaged cleaning article may be subjected to one or more variety of post-entanglement treatments. Such treatments may include application of a polymeric binder composition, mechanical compacting, application of surfactant or electrostatic compositions, and like processes.

In accordance with the present invention, a compound three-dimensionally imaged nonwoven cleaning article comprises the steps of providing a precursor web, which is subjected to a first imparted image, then subsequently, a second imparted image. The imparted image is imparted by hydroentanglement on a three-dimensional image transfer device. The precursor web is formed into a three-dimensionally imaged nonwoven fabric by hydroentanglement on a three-dimensional image transfer device. The image transfer device defines three-dimensional elements against which the precursor web is forced during hydroentanglement, whereby the fibrous constituents of the web are imaged by movement into regions between the three-dimensional elements and surface asperities of the image transfer device.

Subsequent to three-dimensional imaging, the compound imaged nonwoven cleaning article is treated with a performance or aesthetic modifying composition to further alter the fabric structure or to meet end-use article requirements. A polymeric binder composition can be selected to enhance durability characteristics of the cleaning article, while maintaining the desired softness and drapeability of the three-dimensionally imaged article. A surfactant can be applied so as to impart hydrophilic properties. In addition, electrostatic modifying compound can be used to aid in cleaning or dusting applications.

Other features and advantages of the present invention will become readily apparent from the following detailed description, the accompanying drawings, and the appended claims.

### BRIEF DESCRIPTION OF THE DRAWINGS

FIG. 1 is a diagrammatic view of an apparatus for manufacturing a durable nonwoven fabric, embodying the principles of the present invention;

FIG. 2 is a photomicrograph of the fabric herein described in the present invention; and

FIG. 3 is a photomicrograph of a comparable fabric without the compound three-dimensional imaging.

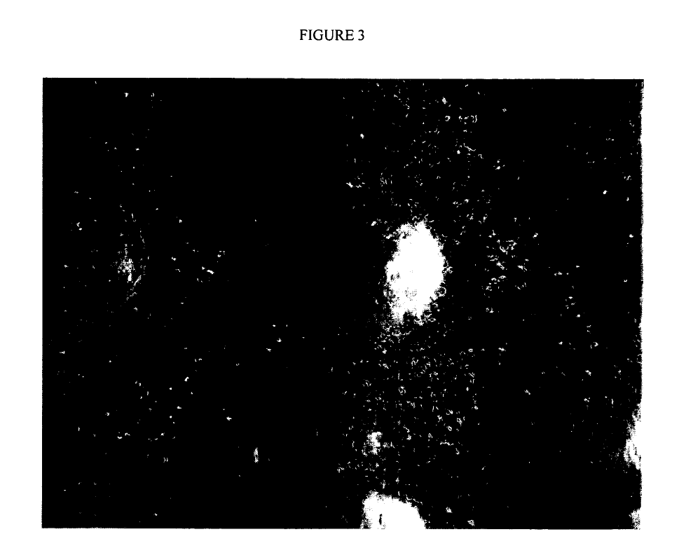

### DETAILED DESCRIPTION

While the present invention is susceptible of embodiment in various forms, there is shown in the drawings, and will hereinafter be described, a presently preferred embodiment of the invention, with the understanding that the present disclosure is to be considered as an exemplification of the invention, and is not intended to limit the invention to the specific embodiment illustrated.

The present invention is directed to a method of forming a nonwoven cleaning article for home care, personal, medical, and industrial cleaning applications, wherein the article is comprised of sequential three-dimensional images comprising at least a first three-dimensional image and a second three-dimensional image whereby the first and second three-dimensional images are dissimilar.

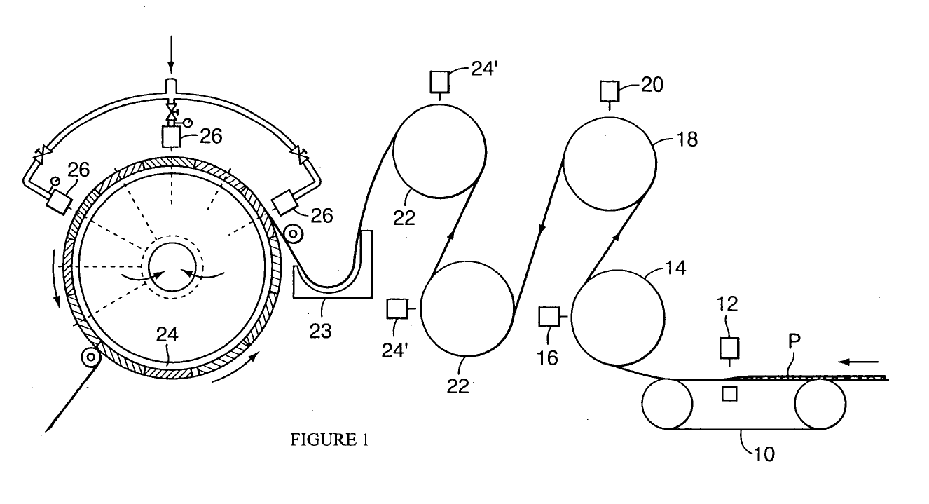

With reference to FIG. 1, therein is illustrated an apparatus for practicing the present method for forming a nonwoven compound three-dimensionally imaged cleaning article. The fabric is formed from a fibrous matrix, which typically comprises staple length fibers, but may comprise substantially continuous filaments. The fibrous matrix is preferably carded and cross-lapped to form a fibrous batt, designated F. In a current embodiment, the fibrous batt comprises 100% cross-lap fibers, that is, all of the fibers of the web have been formed by cross-lapping a carded web so that the fibers are oriented at an angle relative to the machine direction of the resultant web. U.S. Pat. No. 5,475,903, hereby incorporated by reference, illustrates a web drafting apparatus.

The apparatus of FIG. 1 includes a first foraminous-forming surface in the form of belt 10 upon which the precursor web P is positioned for pre-entangling by entangling manifold 12 so as to impart the initial three-dimensional image. Pre-entangling of the precursor web, which hereby imparts a first image, is subsequently effected by movement of the web P sequentially over a second image transfer device, such as drum 14 having a foraminous-forming surface, with entangling manifold 16 effecting entanglement and imparting a second three-dimensional image into the web. Further entanglement of the web is effected on the foraminous forming surface of a drum 18 by entanglement manifold 20, with the web subsequently passed over successive foraminous drums 20, for successive entangling treatment by entangling manifolds 24, 24′.

The entangling apparatus of FIG. 1 further includes a three-dimensional imaging drum 24 comprising a three-dimensional image transfer device for effecting imaging of the now-entangled precursor web which is comprised of at least one three-dimensional image. The image transfer device includes a moveable imaging surface which moves relative to a plurality of entangling manifolds 26 which act in cooperation with three-dimensional elements defined by the imaging surface of the image transfer device to affect additional imaging and patterning of the fabric being formed.

Optionally, a support layer or scrim may be placed in face to face to face juxtaposition with the fibrous web and hydroentangled on a foraminous surface to form a precursor web P with a first three-dimensional image imparted therein. The fibrous web is hydroentangled on a first foraminous surface to form precursor web P and impart a first three-dimensional image. The present invention contemplates that the optional support layer or scrim be any such suitable material, including, but not limited to, wovens, knits, open mesh scrims, and/or nonwoven fabrics, which exhibit low elongation performance. Two particular nonwoven fabrics of particular benefit are spunbond fabrics, as represented by U.S. Pat. No. 3,338,992; No. 3,341,394; No. 3,276,944; No. 3,502,538; No. 3,502,763; No. 3,509,009; No. 3,542,615; and Canadian Pat. No. 803,714, these patents are incorporated by reference, and nanofiber fabrics as represented by U.S. Pat. No. 5,678,379 and No. 6,114,017, both incorporated herein by reference.

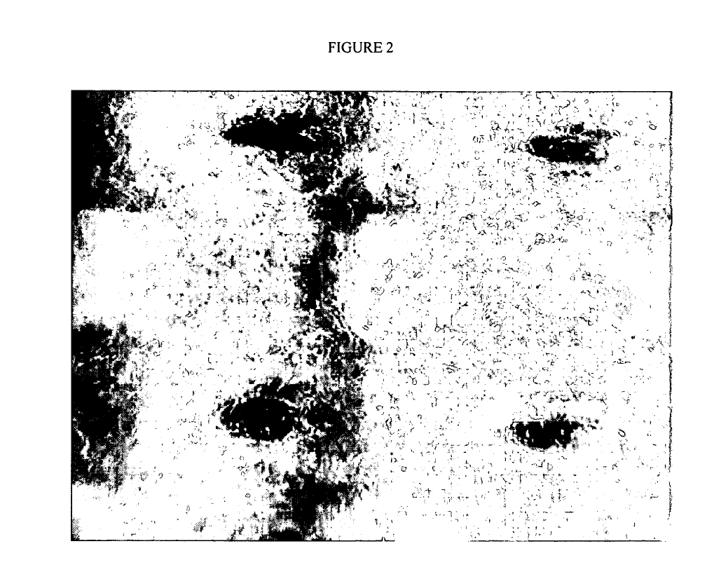

Manufacture of a compound imaged nonwoven cleaning article embodying the principles of the present invention is initiated by providing the fibrous matrix, which can include the use of staple length fibers, continuous filaments, and the blends of fibers and/or filaments having the same or different composition. Fibers and/or filaments are selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers suitable for blending with dispersant thermoplastic resins include polyolefins, polyamides and polyesters. The thermoplastic polymers may be further selected from homopolymers; copolymers, conjugates and other derivatives including those thermoplastic polymers having incorporated melt additives or surface-active agents. Staple lengths are selected in the range of 0.25 inch to 10 inches, the range of 1 to 3 inches being preferred and the fiber denier selected in the range of 1 to 22, the range of 2.0 to 8 denier being preferred for general applications. The profile of the fiber and/or filament is not a limitation to the applicability of the present invention. FIGS. 2 is an example of the cleaning article of the present invention.

In accordance with the present invention, the nonwoven cleaning article includes the use of various aqueous and non-aqueous compositions. The cleaning article embodying the principles of the present invention is especially suitable for home care cleaning or cleansing articles. The nonwoven article may be used in various home care applications, wherein the end use article may be a dry or wet hand held sheet, such as a wipe, a mitt formation, or a cleaning implement capable of retaining the cleaning article. The various end uses suitable for cleaning household surfaces such as, kitchen and bathroom countertops, sinks, bathtubs, showers, appliances, and fixtures.

Cleaning compositions suitable for such end use applications include those that are described in U.S. Pat. No. 6,103,683 to Romano, et al., No. 6,340,663 to Deleo, et al., No. 5,108,642 to Aszman, et al., and No. 6,534,472 Arvanitidou, et al., all of which are hereby incorporated by reference. Selected cleaning compositions may also include surfactants, such as alkylpolysaccharides, alkyl ethoxylates, alkyl sulfonates, and mixtures thereof; organic solvent, mono- or polycarboxylic acids, odor control agents, such as cyclodextrin, peroxides, such as benzoyl peroxide, hydrogen peroxide, and mixtures thereof, thickening polymers, aqueous solvent systems, suds suppressors, perfumes or fragrances, and detergent adjuvants, such as detergency builder, buffer, preservative, antibacterial agent, colorant, bleaching agents, chelants, enzymes, hydrotropes, and mixtures thereof. The aforementioned compositions preferably comprise from about 50% to about 500%, preferably from about 200% to about 400% by weight of the nonwoven cleaning article.

The nonwoven cleaning article embodying the principles of the present invention is also suitable for personal cleaning or cleansing articles. Non-limiting examples of such applications include dry or wet facial wipes, body wipes, and baby wipes. Suitable methods for the application of various aqueous and non-aqueous compositions comprise aqueous/alcoholic impregnates, including flood coating, spray coating or metered dosing. Further, more specialized techniques, such as Meyer Rod, floating knife or doctor blade, which are typically used to impregnate cleansing solutions into absorbent sheets, may also be used. The following compositions preferably comprise from about 50% to about 500%, preferably from about 200% to about 400% by weight of the nonwoven cleaning article.

The nonwoven article may incorporate an alpha-hydroxycarboxylic acid, which refers not only the acid form but also salts thereof. Typical cationic counterions to form the salt are the alkali metals, alkaline earth metals, ammonium, C₂ -C₈ trialkanolammonium cation and mixtures thereof. The term “alpha-hydroxycarboxylic acids” include not only hydroxyacids but also alpha-ketoacids and related compounds of polymeric forms of hydroxyacid.

Amounts of the alpha-hydroxycarboxylic acids may range from about 0.01 to about 20%, preferably from about 0.1 to about 15%, more preferably from about 1 to about 10%, optimally from about 3 to about 8% by weight of the composition which impregnates the substrate. The amount of impregnating composition relative to the substrate may range from about 20:1 to 1:20, preferably from 10:1 to about 1:10 and optimally from about 2:1 to about 1:2 by weight.

Further, a humectant may be incorporated with the aforementioned alpha-hydroxycarboxylic compositions. Humectants are normally polyols. Representative polyols include glycerin, diglycerin, polyalkylene glycols and more preferably alkylene polyols and their derivatives. Amounts of the polyol may range from about 0.5 to about 95%, preferably from about 1 to about 50%, more preferably from about 1.5 to 20%, optimally from about 3 to about 10% by weight of the impregnating composition.

A variety of cosmetically acceptable carrier vehicles may be employed although the carrier vehicle normally will be water. Amounts of the carrier vehicle may range from about 0.5 to about 99%, preferably from about 1 to about 80%, more preferably from about 50 to about 70%, optimally from about 65 to 75% by weight of the impregnating composition.

Preservatives can desirably be incorporated protect against the growth of potentially harmful microorganisms. Suitable traditional preservatives for compositions of this invention are alkyl esters of para-hydroxybenzoic acid. Other preservatives which have more recently come into use include hydantoin derivatives, propionate salts, and a variety of quatenary ammonium compounds. Preservatives are preferably employed in amounts ranging from 0.01% to 2% by weight of the composition.

The cosmetic composition may further include herbal extracts. Illustrative extracts include Roman Chamomile, Green Tea, Scullcap, Nettle Root, Swertia laponica, Fennel and Aloe Vera extracts. Amount of each of the extracts may range from about 0.001 to about 1%, preferably from about 0.01 to about 0.5%, optimally from about 0.05 to about 0.2% by weight of a composition.

Additional cosmetic additives may also include vitamins such as Vitamin E Acetate, Vitamin C, Vitamin A Palmitate, Panthenol and any of the Vitamin B complexes. Anti-irritant agents may also be present including those of steviosides, alpha-bisabolol and glycyhrizzinate salts, each vitamin or anti-irritant agent being present in amounts ranging from about 0.001 to about 1.0%, preferably from about 0.01 to about 0.3% by weight of the composition.

These impregnating compositions of the present invention may involve a range of pH although it is preferred to have a relatively low pH, for instance, a pH from about 2 to about 6.5, preferably from about 2.5 to about 4.5.

In addition to cosmetic compositions, lotions may be incorporated into the nonwoven article. The lotion preferably also comprises one or more of the following: an effective amount of a preservative, an effective amount of a humectant, an effective amount of an emollient; an effective amount of a fragrance, and an effective amount of a fragrance solubilizer.

As used herein, an emollient is a material that softens, soothes, supples, coats, lubricates, or moisturizes the skin. The term emollient includes, but is not limited to, conventional lipid materials (e.g. fats, waxes), polar lipids (lipids that have been hydrophylically modified to render them more water soluble), silicones, hydrocarbons, and other solvent materials. Emollients useful in the present invention can be petroleum based, fatty acid ester type, alkyl ethoxylate type, fatty acid ester ethoxylates, fatty alcohol type, polysiloxane type, mucopolysaccharides, or mixtures thereof.

Humectants are hygroscopic materials that function to draw water into the stratum comeum to hydrate the skin. The water may come from the dermis or from the atmosphere. Examples of humectants include glycerin, propylene glycol, and phospholipids.

Fragrance components, such as perfumes, include, but are not limited to water insoluble oils, including essential oils. Fragrance solubilizers are components which reduce the tendency of the water insoluble fragrance component to precipitate from the lotion. Examples of fragrance solubilizers include alcohols such as ethanol, isopropanol, benzyl alcohol, and phenoxyethanol; any high HLB (HLB greater than 13) emulsifier, including but not limited to polysorbate; and highly ethoxylated acids and alcohols.

Preservatives prevent the growth of micro-organisms in the liquid lotion and/or the substrate. Generally, such preservatives are hydrophobic or hydrophilic organic molecules. Suitable preservatives include, but are not limited to parabens, such as methyl parabens, propyl parabens, and combinations thereof.

The lotion can also comprise an effective amount of a kerotolytic for providing the function of encouraging healing of the skin. An especially preferred kerotolytic is Allantoin ((2,5-Dioxo-4-Imidazolidinyl)Urea), a heterocyclic organic compound having an empirical formula C₄ H₆ N₄ O₃. Allantoin is commercially available from Tri-K Industries of Emerson, N.J. It is generally known that hyperhydrated skin is more susceptible to skin disorders, including heat rash, abrasion, pressure marks and skin barrier loss. A pre-moistened wipe according to the present invention can include an effective amount of allantoin for encouraging the healing of skin, such as skin which is over hydrated.

U.S. Pat. No. 5,534,265 issued Jul. 9, 1996; U.S. Pat. No. 5,043,155 issued Aug. 27, 1991; and U.S. Pat. No. 5,648,083 issued Jul. 15, 1997 are incorporated herein by reference for the purpose of disclosing additional lotion ingredients.

The lotion can further comprise between about 0.1 and about 3 percent by eight Allantoin, and about 0.1 to about 10 percent by weight of an aloe extract, such as aloe vera, which can serve as an emollient. Aloe vera extract is available in the form of a concentrated powder from the Rita Corporation of Woodstock, Ill.

Further, latherants may be incorporated within the cleaning article. Non-limiting examples of anionic lathering surfactants useful in the compositions of the present invention are disclosed in McCutcheon's, Detergents and Emulsifiers, North American edition (1986), published by allured Publishing Corporation; McCutcheon's, Functional Materials, North American Edition (1992); and U.S. Pat. No. 3,929,678, to Laughlin et al., issued Dec. 30, 1975, all of which are incorporated by reference herein in their entirety. A wide variety of anionic lathering surfactants are useful herein. Non-limiting examples of anionic lathering surfactants include those selected from the group consisting of sarcosinates, sulfates, isethionates, taurates, phosphates, lactylates, glutamates, and mixtures thereof.

Non-limiting examples of nonionic lathering surfactants and amphoteric surfactants for use in the compositions of the present invention are disclosed in McCutcheon's, Detergents and Emulsifiers, North American edition (1986), published by allured Publishing Corporation; and McCutcheon's, Functional Materials, North American Edition (1992); both of which are incorporated by reference herein in their entirety.

Nonionic lathering surfactants useful herein include those selected from the group consisting of alkyl glucosides, alkyl polyglucosides, polyhydroxy fatty acid amides, alkoxylated fatty acid esters, lathering sucrose esters, amine oxides, and mixtures thereof.

The term “amphoteric lathering surfactant,” as used herein, is also intended to encompass zwitterionic surfactants, which are well known to formulators skilled in the art as a subset of amphoteric surfactants.

A wide variety of amphoteric lathering surfactants can be used in the compositions of the present invention. Particularly useful are those which are broadly described as derivatives of aliphatic secondary and tertiary amines, preferably wherein the nitrogen is in a cationic state, in which the aliphatic radicals can be straight or branched chain and wherein one of the radicals contains an ionizable water solubilizing group, e.g., carboxy, sulfonate, sulfate, phosphate, or phosphonate. Non-limiting examples of amphoteric or zwitterionic surfactants are those selected from the group consisting of betaines, sultaines, hydroxysultaines, alkyliminoacetates, iminodialkanoates, aminoalkanoates, and mixtures thereof.

Additional compositions utilized in accordance with the present invention can comprise a wide range of optional ingredients. The CTFA International Cosmetic ingredient Dictionary, Sixth Edition, 1995, which is incorporated by reference herein in its entirety, describes a wide variety of non-limiting cosmetic and pharmaceutical ingredients commonly used in the skin care industry, which are suitable for use in the compositions of the present invention. Non-limiting examples of functional classes of ingredients are described at page 537 of this reference. Examples of these functional classes include: abrasives, anti-acne agents, anti-caking agents, antioxidants, binders, biological additives, bulking agents, chelating agents, chemical additives, colorants, cosmetic astringents, cosmetic biocides, degreasers, denaturants, drug astringents, emulsifiers, external analgesics, film formers, fragrance components, humectants, opacifying agents, plasticizers, preservatives, propellants, reducing agents, skin bleaching agents, skin-conditioning agents (emollient, humectants, miscellaneous, and occlusive), skin protectants, solvents, foam boosters, hydrotropes, solubilizing agents, suspending agents (nonsurfactant), sunscreen agents, ultraviolet light absorbers, and viscosity increasing agents (aqueous and nonaqueous). Examples of other functional classes of materials useful herein that are well known to one of ordinary skill in the art include solubilizing agents, sequestrants, and keratolytics, and the like.

The aforementioned classes of ingredients are incorporated in a safe and effective amount. The term “safe and effective amount” as used herein, means an amount of an active ingredient high enough to modify the condition to be treated or to deliver the desired skin benefit, but low enough to avoid serious side effects, at a reasonable benefit to risk ratio within the scope of sound medical judgment.

In addition to home care and personal care end uses, the nonwoven cleaning article may be used in industrial and medical applications. For instance, the cleaning article may be useful in paint preparation and cleaning outdoor surfaces, such as lawn furniture, grills, and outdoor equipment, wherein the low linting attributes of the laminate may be desirable. Aqueous or non-aqueous functional industrial solvents include, oils, such as plant oils, animal oils, terpenoids, silicon oils, mineral oils, white mineral oils, paraffinic solvents, polybutylenes, polyisobutylenes, polyalphaolefins, and mixtures thereof, toluenes, sequestering agents, corrosion inhibitors, abrasives, petroleum distillates, and the combinations thereof.

A medical cleaning article may incorporate an antimicrobial composition, including, but not limited to iodines, alcohols, such as such as ethanol or propanol, biocides, abrasives, metallic materials, such as metal oxide, metal salt, metal complex, metal alloy or mixtures thereof, bacteriostatic complexes, bactericidal complexes, and the combinations thereof.

The cleaning article of the present invention is particularly suitable for dispensing from a tub of stacked, folded wipes, or for dispensing as “pop-up” wipes, in which the cleaning article is stored in the tub as a perforated continuous roll, wherein upon pulling a wipe out of the tub, an edge of the next wipe is presented for easy dispensing. The wipes of the present invention can be folded in any of various known folding patterns, such as C-folding, but is preferably Z-folded. A Z-folded configuration enables a folded stack of wipes to be interleaved with overlapping portions. The cleaning article may be packaged in various convenient forms, whereby the method of packaging is not meant to be a limitation of the present invention.

From the foregoing, numerous modifications and variations can be effected without departing from the true spirit and scope of the novel concept of the present invention. It is to be understood that no limitation with respect to the specific embodiment disclosed herein is intended or should be inferred. The disclosure is intended to cover, by the appended claims, all such modifications as fall within the scope of the claims.

What is claimed is:

1. A method of making a nonwoven home care cleaning article comprising the steps of:
a. providing a nonwoven fabric, wherein said nonwoven fabric is subject to hydraulic energy upon at least a first three-dimensional image transfer device and a second three-dimensional image transfer device, said fabric comprising at least a first three-dimensional image and a second three-dimensional image wherein said first three-dimensional image differs from said second three-dimensional image; and
b. a cleansing composition comprising an effective amount of a cleansing surfactant, said aqueous liquid cleansing composition being coated onto or impregnated into said substrate to the extent of from 50% to 500% by weight of the substrate.

2. A method of making a nonwoven home care cleaning article as in claim 1, wherein said cleansing composition is an aqueous or non-aqueous composition.

3. A method of making a nonwoven home care cleaning article as in claim 1, wherein said cleansing composition is selected from the group consisting of alkylpolysaccharides, alkyl ethoxylates, alkyl sulfonates, organic solvents, mono- or polycarboxylic acids, odor control agents, peroxides, hydrogen peroxides, thickening polymers, aqueous solvent systems, suds suppressors, perfumes or fragrances, detergent adjuvants, buffers, preservatives, antibacterial agents, colorants, bleaching agents, abrasive compounds, degreasers, chelants, enzymes, hydrotropes, and the combinations thereof.

4. A method of making a nonwoven personal care cleaning article comprising the steps of:
a. providing a nonwoven fabric, wherein said nonwoven fabric is subject to hydraulic energy upon at least a first three-dimensional image transfer device and a second three-dimensional image transfer device, said fabric comprising at least a first three-dimensional image and a second three-dimensional image wherein said first three-dimensional image differs from said second three-dimensional image; and
b. a cleansing composition comprising an effective amount of a cleansing surfactant, said aqueous liquid cleansing composition being coated onto or impregnated into said substrate to the extent of from 50% to 500% by weight of the substrate.

5. A method of making a nonwoven personal care cleaning article as in claim 4, wherein said cleansing composition is an aqueous or non-aqueous composition.

6. A method of making a nonwoven personal care cleaning article as in claim 4, wherein said cleansing composition is selected from the group consisting of abrasives, anti-acne agents, anticaking agents, antioxidants, binders, biological additives, bulking agents, chelating agents, chemical additives, natural additives, colorants, vitamins, cosmetic astringents, cosmetic biocides, denaturants, drug astringents, emulsifiers, external analgesics, film formers, fragrance components, humectants, emollients, opacifying agents, plasticizers, preservatives, propellants, reducing agents, skin bleaching agents, skin-conditioning agents, skin protectants, solvents, foam boosters, hydrotropes, solubilizing agents, suspending agents, sunscreen agents, ultraviolet light absorbers, viscosity increasing agents, and the combinations thereof.

7. A method of making a nonwoven industrial cleaning article comprising the steps of:
a. providing a nonwoven fabric, wherein said nonwoven fabric is subject to hydraulic energy upon at least a first three-dimensional image transfer device and a second three-dimensional image transfer device, said fabric comprising at least a first three-dimensional image and a second three-dimensional image wherein said first three-dimensional image differs from said second three-dimensional image; and
b. a cleansing composition comprising an effective amount of a cleansing surfactant, said aqueous liquid cleansing composition being coated onto or impregnated into said substrate to the extent of from 50% to 500% by weight of the substrate.

8. A method of making a nonwoven industrial cleaning article as in claim 7, wherein said cleansing composition is an aqueous or non-aqueous composition.

9. A method of making a nonwoven industrial cleaning article as in claim 7, wherein said cleansing composition is a solvent selected from the group consisting of oils, paraffinic solvents, polybutylenes, polyisobutylenes, polyalphaolefins, toluenes, sequestering agents, corrosion inhibitors, abrasives, petroleum distillates, and the combinations thereof.

10. A method of making a nonwoven medical cleaning article comprising the steps of:
a. providing a nonwoven fabric, wherein said nonwoven fabric is subject to hydraulic energy upon at least a first three-dimensional image transfer device and a second three-dimensional image transfer device, said fabric comprising at least a first three-dimensional image and a second three-dimensional image wherein said first three-dimensional image differs from said second three-dimensional image; and
b. a cleansing composition comprising an effective amount of a cleansing surfactant, said aqueous liquid cleansing composition being coated onto or impregnated into said substrate to the extent of from 50% to 500% by weight of the substrate.

11. A method of making a nonwoven personal care cleaning article as in claim 10, wherein said cleansing composition is an aqueous or non-aqueous composition.

12. A method of making a nonwoven personal care cleaning article as in claim 10, wherein said cleansing composition is selected from the group consisting of iodines, alcohols, biocides, abrasives, metallic materials, bacteriostatic complexes, bactericidal complexes, and the combinations thereof.
